(19) United States
(12) Patent Application Publication
(10) Pub. No.: US 2011/0132510 A1
(43) Pub. Date: Jun. 9, 2011

(54) WHEEL-TIRE COMBINATION FOR VEHICLES

(76) Inventor: Edgar Carrasco, Basel (CH)

(21) Appl. No.: 13/057,218

(22) PCT Filed: Aug. 6, 2009
(86) PCT No.: PCT/EP2009/060227

§ 371 Date: Feb. 2, 2011

(30) Foreign Application Priority Data
Aug. 6, 2008 (CH) 01225/08

(51) Int. Cl. B60C 7/00

(52) U.S. Cl. 152/311

(57) ABSTRACT

The invention relates to a vehicle wheel, comprising a rigid rim and a flexible tire without an air charge, between which resilient spokes, offset at an angle with respect to the radial direction, are situated. The spokes are divided into three or more groups, which are separated axially from one another with an alternating oppositely directed angular offset.

The invention relates to a vehicle wheel, comprising a rigid rim and a flexible tire without an air charge, between which resilient spokes, offset at an angle with respect to the radial direction, are situated.

For the purpose of this description, the terms given below have the following meanings: The term “spoke” includes resilient connecting elements between the rim and the tire, and the term “rim” includes a rigid element, generally having a circular disk shape, which is connected to or provided with a hub, or optionally only a hub. The term “tire” includes an annular flexible element which externally encloses the wheel and which may be provided with an elastic tread. The “width” of a wheel and its elements refers to the dimensions thereof in the axial direction. For the wheels considered here, the elements of the rim or hub, spokes, and tire typically have approximately the same width.

For a considerable period of time after the invention of the wheel, the wheel was rigid, i.e., had no resilient parts. If resiliency was required, this was achieved solely by means of the wheel suspension. Rigid wheels have been used frequently heretofore, for example in railway transportation. With the development of road vehicles, initially wheels having an elastic tire and, subsequently, the pneumatic wheel, were developed and perfected.

One problem of pneumatic tires for which no real solution has been found thus far is the risk of damage upon pressure loss, as the result of which the tire is immediately unusable and the vehicle is undrivable.

For quite some time, development has been underway to provide a wheel which does not require pneumatic tires. The resiliency which is inherent to the wheel is provided by elastic spokes which connect the tire to a rim or hub. Although the tire is elastic, it is flat and has no air charge. One example of such a development is the so-called Tweel from Michelin. Other tire manufacturers are developing similar concepts.

In most of these developments the elastic spokes are radially positioned. There are also developments in which the spokes are offset at an angle with respect to the radial direction, which in comparison to radial spokes offer several advantages, for example a longer and more well-defined spring excursion. However, these wheels are unsatisfactory with regard to the lateral relative motion between the hub and the tire.

The object of the invention is to provide a wheel of the type described at the outset which does not have the disadvantages of the known wheels of this type.

This is achieved according to the invention by dividing the spokes into at least three or more groups which are separated axially from one another with an alternating oppositely directed angular offset.

The width of the spokes, i.e., the extension of the spokes in the axial direction, is preferably different in the individual groups.

Preferred exemplary embodiments of the invention are described below with reference to the accompanying drawings, which show the following:

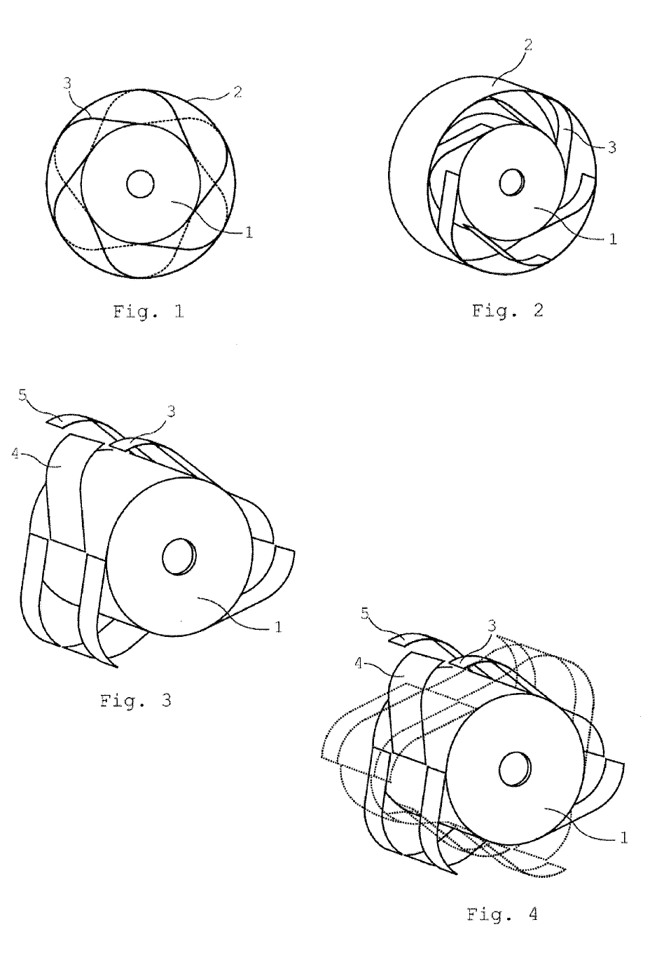

FIG. 1 shows a side view in the axial direction of a wheel according to one embodiment of the invention, having six spokes per group;

FIG. 2 shows a perspective view of the embodiment according to FIG. 2;

FIG. 3 shows a perspective view of the embodiment according to FIG. 2, but without the tire, and having three spokes per group;

FIG. 4 shows a perspective illustration similar to that of FIG. 3, but having six spokes per group;

FIG. 5 shows a perspective illustration similar to that of FIG. 3, but having four groups of spokes;

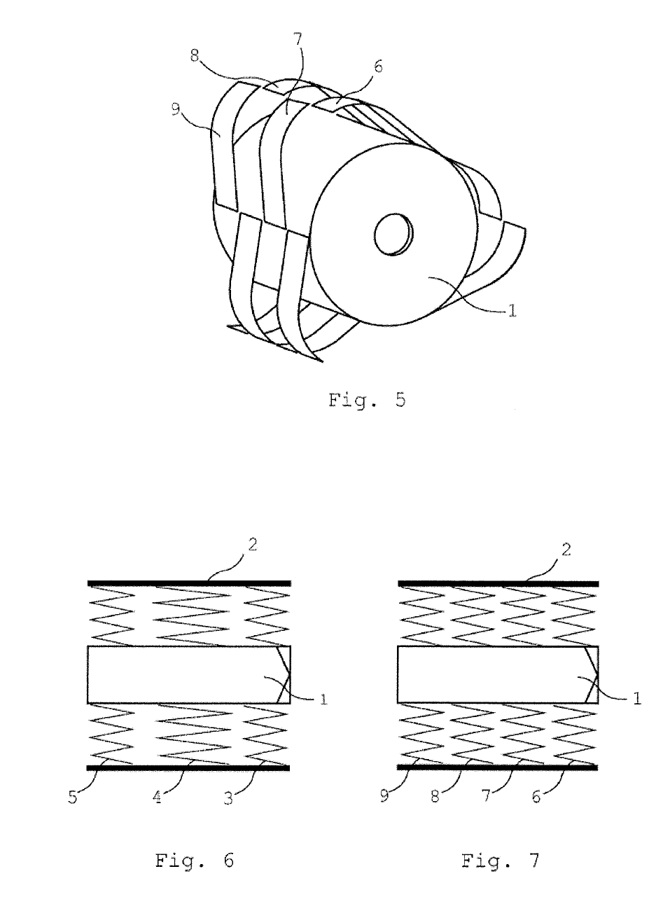

FIG. 6 shows a schematic illustration of a cross section of a wheel having three groups of spokes, shown in an axial plane;

FIG. 7 shows a schematic illustration of a cross section of a wheel having four groups of spokes, shown in an axial plane;

FIG. 8 shows the situation of absorption of force, i.e., the support, for a wheel having 12 spokes per group, and three or more groups having different rotational angles; and

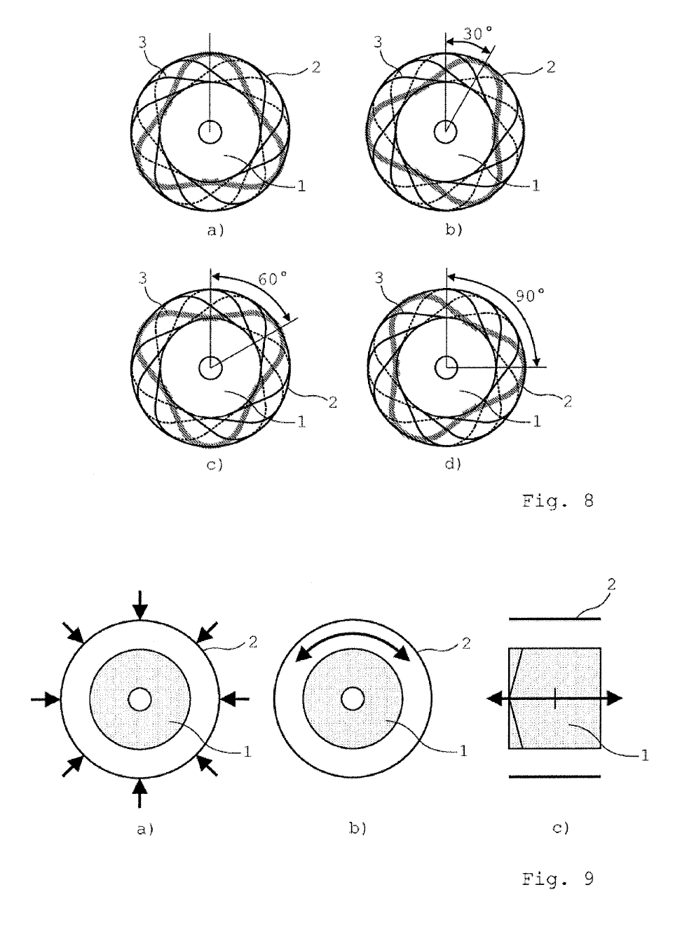

FIG. 9 shows a schematic illustration of the effect of radial, tangential, and axial forces on the wheel.

As schematically shown in FIGS. 1 and 2, one embodiment of the wheel according to the invention comprises a rim 1 and a tire 2 situated coaxially therewith. The rim and tire are joined together by spokes 3 which are offset at an angle with respect to the radial direction. The spokes are configured in such a way that at their connection to the rim and to the tire the transition is approximately tangential. For this purpose the spokes are bent at one end.

It is apparent from FIG. 2 and in particular from FIG. 3 that the spokes have the shape of thin sheets, and have a small thickness compared to their length and width. The spokes are made of an elastic material, for example spring steel.

For clarity, only the spokes closest to the observer are shown in the perspective illustration of FIG. 2. In order to first clearly illustrate the principle, in FIG. 3 fewer spokes are illustrated, and the tire is omitted. It is apparent that the spokes are situated in three groups. The spokes 3 situated at an end face of the rim 1 form a first group. The spokes 5 located at the oppositely situated end face are oriented identically to the spokes 3 of the first group, and form a second group. The spokes 4 situated therebetween are oppositely directed with respect to the spokes of the other two groups, and form a third group.

In a corresponding illustration, FIG. 4 shows six spokes per group, i.e., the number shown in FIGS. 1 and 2. However, in each group every other spoke is shown in dotted lines for the sake of clarity.

It may be identified in FIGS. 3 and 4 that the spokes of the middle, third group are wider than those of the two outer groups. The spokes of the two outer groups have a width that is approximately 60-80% of the width of the spokes in the middle group. As a result, the mechanical, in particular the elastic, properties are uniformly, i.e., symmetrically, distributed over the spokes having different orientations.

By varying the width of the spokes, these properties may be modified within certain limits; i.e., targeted deviations from the symmetrical distribution may be achieved. Another possibility for varying the properties lies in providing different thicknesses of the spokes in the individual groups. Lastly, changes in material properties, for example the elasticity, may also be made.

The length of the spokes may also be varied for influencing the properties of the wheel. Furthermore, there is an additional coordination possibility by adapting the properties of the spokes to the properties of the tire, whose flexibility is likewise determined by the material, thickness, width, and circumference, and by the number of support points formed by the spokes.

FIG. 5 illustrates a version having four groups of spokes 6-9, once again only three spokes per group being shown for the sake of clarity. In the embodiment having four groups, all spokes preferably have the same width. In practical application a greater number of spokes may be provided, i.e., at least six per group, but also many more, for example 12 or 24, depending on the application. As a rule, the number is such that uniform distribution over a circumference may be achieved.

In all embodiments, for achieving a particular effect, groups of spokes or individual spokes may be displaced with respect to one another in the rotational direction, for example in such a way that they interlock in a comb-like manner.

FIGS. 6 and 7 show a schematic illustration of a cross section in an axial plane. The spokes are represented in a type of alternative illustration as spiral springs in order to elucidate the elastic effect of the spokes.

FIG. 8 shows the situation of absorption of force, i.e., the support, for a wheel having 12 spokes per group, and three or more groups having different rotational angles. For a configuration having only two groups of spokes, a force directed perpendicularly on the tread of the tire would act only at the support point of the spokes on the tire, symmetrically along the tire. In contrast, for three or more groups of spokes the symmetrical action of force is maintained at a distance from the support point of the spokes along the exterior of the tire. The cross section and the center line of the tire form the plane of symmetry.

FIG. 9 shows a schematic illustration of the effect of radial, tangential, and axial forces on the wheel. As shown in FIG. 9a, when there are a sufficient number of support points the property of homogeneous deformation of the tire results when there is constant action of perpendicular force on the tire.

As indicated in FIG. 9b, the action of a torque on the rim results in a slight rotational displacement of the rim relative to the tire. However, this causes practically no impairment of the transmission of torque from the rim to the tire. FIG. 9c shows the action of an axial force on the wheel. The displacement of the rim relative to the tire is small.

Very low-noise operation is achieved due to the bending of the spokes. The spokes are connected to the rim and to the tire using various connection techniques, for example welding, adhesive bonding, screwing, etc. The spokes may also be designed in one piece. The spokes and tire may be made of spring steel and provided with an elastomer coating.

The above-described wheel may be constructed in any practical size, and used for automobiles as well as for numerous other vehicles. The larger the diameter, the more spokes which may be accommodated per group. Of course, the number of spokes may be varied from group to group when this is required for the desired properties.

1. Vehicle wheel, comprising a rigid rim and a flexible tire without an air charge, between which resilient spokes, offset at an angle with respect to the radial direction, are situated, characterized in that the spokes are divided into at least three groups, which are separated axially from one another with an alternating oppositely directed angular offset.

2. Vehicle wheel according to claim 1, characterized in that the width of the spokes is different in the individual groups.

3. Vehicle wheel according to claim 1, characterized in that the spokes are divided into four groups which are separated axially from one another.

4. Vehicle wheel according to claim 1, characterized in that the groups comprise spokes which are uniformly distributed over the circumference.

5. Vehicle wheel according to claim 4, characterized in that a group comprises six spokes which are uniformly distributed over the circumference.

6. Vehicle wheel according to claim 1, characterized in that the spokes of individual groups are displaced with respect to the other groups in the rotational direction.
